(19) United States
(12) Patent Application Publication
(10) Pub. No.: US 2020/0306952 A1
(43) Pub. Date: Oct. 1, 2020

(54) System, Method and/or Computer Readable Medium for Controlling an Exoskeleton

(71) Applicant: Bionik, Inc., Watertown, MA (US)

(72) Inventor: Negin Lashkari, Markham (CA)

(73) Assignee: Bionik, Inc., Watertown, MA (US)

(21) Appl. No.: 16/371,353

(22) Filed: Apr. 1, 2019

(51) Int. Cl. B25J 9/00; B25J 9/16

(52) U.S. Cl. CPC B25J 9/0006; B25J 9/0009; B25J 9/1633

(57) ABSTRACT

Disclosed is a system, method and/or computer readable medium for controlling an exoskeleton associated with a user. The exoskeleton includes a body portion secured to an abdominal section of the user and a limb structure secured to one or more thighs of the user. The limb structure is pivotally connected to the body portion to facilitate rotation of the limb structure about a pivot axis. One or more sensors, associated with the exoskeleton, receive input data related to a movement of the user. Also included is a processor to automatically analyze the input data using one or more algorithms to generate output data having a torque based on the movement of the user. A drive force transmission mechanism associated with the body portion and the limb structure of the exoskeleton is provided to receive the output data from the processor and generate the torque to move the limb structure about the pivot axis.

### FIELD OF THE INVENTION

The present invention relates generally to the control of an exoskeleton. In particular, the present invention relates to a system, method and/or computer readable medium to control actuators associated with the exoskeleton to support ambulatory movement.

### BACKGROUND OF THE INVENTION

In the prior art, different solutions have been developed for controlling exoskeletons. The prior art attempts, however, have been limited to the extent that they depend on gaits, predetermined trajectories, and/or biosignals of the user (e.g., electromyogram, or EMG, sensors) which may require implantation, direct skin contact, drive a user to unintended motion and/or restrict movement. A further disadvantage of prior art solutions requiring implantation or direct skin contact are the potential for unsanitary conditions leading to infections and/or disease.

In U.S. Patent Application Publication No. 20160067061A1 to Honda Motor Co Ltd., there is disclosed integral admittance shaping for an exoskeleton control design framework. An assistive exoskeleton control system has a controller generating a positive assistance by shaping a closed loop integral admittance of a coupled human exoskeleton system to a desired assistance ratio A_{d} by modifying a control transfer function using a cut-off frequency of a low pass filter. Honda Motor Co Ltd.'s exoskeleton appears to be designed, however, only for providing a reduction in metabolic cost for walking or running and uses a predefined gait profile. As such, it may fail to take into account and react accordingly to discrete movements by a user.

In U.S. Patent Application Publication No. 20130226048A1 to Northeastern University China, there is disclosed a lower extremity exoskeleton for gait retraining. The Active Knee Rehabilitation Orthotic System (ANdROS) is a wearable and portable assistive tool for gait rehabilitation and monitoring of people with motor control deficits due to a neurological ailment, such as stroke. ANdROS reinforces a desired gait pattern by continually applying a corrective torque around the knee joint, commanded by a impedance controller. A sensorized yet unactuated brace worn on the unimpaired leg is used to synchronize the playback of the desired trajectory based on the user's intent. The device is mechanically grounded through two ankle foot orthoses (AFOs) rigidly attached to the main structure, which helps reduce the weight perceived by the user. ANdROS, however, may fail to provide for control mechanisms for people with dual limb impairment and is only designed to apply an actuated force to a single injured leg. In addition, the device may fail to predict movement based on the actions of the impaired leg.

In U.S. Patent Application Publication No. 20150134080A1 to Samsung Electronics Co Ltd., there is disclosed a wearable robot and method for controlling the same. A wearable robot may include a gear part having an exoskeleton structure to be worn on legs of a user, a sensor part including a first electromyogram (“EMG”) sensor attached at a first location of at least one leg of the user, and a second EMG sensor attached at a second location, and a controller to detect a walking assist starting point to assist the user with walking, based on a first EMG signal detected by the first EMG sensor and a second EMG signal detected by the second EMG sensor. In addition to the disadvantage with EMG sensors discussed earlier, it is a known disadvantage that EMG signals may be unreliable with patients who are obese or advanced in age. Accordingly, Samsung Electronics Co Ltd.'s wearable robot may be unable to overcome fundamental issues associated with providing comfortable, reliable, and long term use of an exoskeleton.

In U.S. Patent Application Publication No. 20170027801A1 to Samsung Electronics Co Ltd., there is disclosed walking assistance methods and apparatuses performing the same. A walking assistance method may include: computing an amount of exercise of a user based on a biosignal of the user; adjusting a pattern of an assist parameter based on the amount of exercise; and/or generating a force corresponding to the amount of exercise, based on the adjusted pattern. A walking assistance apparatus may include: a pattern adjuster configured to compute an amount of exercise of a user based on a biosignal of the user; and/or a driver configured to generate a force corresponding to the amount of exercise based on a pattern of an assist parameter based on the amount of exercise. Biosignals however, as described in the patent may be disadvantageous in that they require invasive and often faulty sensors to be placed on the user to measure heart rates, breathing speeds, blood oxygen concentrations, lactic acid concentrations, or amounts of sweat.

In U.S. Patent Application Publication No. 20170056211A1 of Samsung Electronics Co Ltd., there is disclosed a walking assistance apparatus and operation method of the same. A walking assistance apparatus may include a driver configured to assist movements of a first joint related to a right leg of a user and a second joint related to a left leg of the user, a sensor configured to measure a first joint angle corresponding to the first joint and a second joint angle corresponding to the second joint, and a controller configured to generate a walking assist profile based on a previous step of the user, modify the walking assist profile based on the first and the second joint angles, and control the driver based on the modified walking assist profile. Samsung Electronics Co Ltd.'s walking assistance apparatus does not provide for control mechanisms for people with dual limb impairment and is only designed to apply an assistive force to a single injured leg based on a user's previous steps. The device may also fail to predict movement based on the actions of the impaired leg.

Accordingly, determining the torque to be applied by an exoskeleton in the prior art has involved the use of invasive or ineffective sensors, including recording muscle activity through the skin. The layers of tissue and skin between the muscle and the sensor can distort the motor signal impairing the controllability of the exoskeleton. Furthermore the external electrodes can also behave differently or fail depending on skin temperature and moisture. Alternatively, invasive sensors have also been used in the art involving either surgically implanted electrodes or myoelectric control, which relies upon electrical signals from muscles. It is a problem in the art to develop reliable and non-invasive ways of determining torques to be applied by an exoskeleton.

As a result, there may be a need for, or it may be desirable to provide a lower body exoskeleton and/or cooperating environment that overcomes one or more of the limitations associated with the prior art.

### SUMMARY OF THE INVENTION

The present disclosure provides a system, method and/or computer readable medium for controlling an exoskeleton associated with a user. The exoskeleton includes a body portion secured to an abdominal section of the user and a limb structure secured to one or more thighs of the user. The limb structure is pivotally connected to the body portion to facilitate rotation of the limb structure about a pivot axis.

According to an aspect of one preferred embodiment of the invention, there is disclosed a system for controlling an exoskeleton associated with a user. The system includes one or more sensors adapted to receive input data associated with a movement of the user at a predetermined time or time intervals, the one or more sensors having an encoder adapted to receive movement data and an inertial measurement unit adapted to receive physiological data. The system also includes a processor operative to electronically receive the input data from the one or more sensors and automatically analyze the input data to generate output data. The input data is processed by one or more algorithms to determine a torque based on the movement of the user, with the torque forming at least a part of the output data. The system also includes a drive force transmission mechanism associated with the body portion and the limb structure of the exoskeleton. The drive force transmission mechanism is adapted to receive the output data from the processor and generate the torque to move the limb structure about the pivot axis. Thus, according to the invention, the system is operative to facilitate the control of the exoskeleton by generating the torque to support the movement of the user.

According to an aspect of one preferred embodiment of the invention, the movement data may preferably, but need not necessarily, include angular position, velocity and/or acceleration of the one or more thighs of the user.

According to an aspect of one preferred embodiment of the invention, the physiological data may preferably, but need not necessarily, include specific force and/or angular rate of the one or more thighs of the user.

According to an aspect of one preferred embodiment of the invention, the system may preferably, but need not necessarily, include a database for storing input data, movement data, physiological data, and/or output data.

According to an aspect of one preferred embodiment of the invention, the one or more algorithms may preferably, but need not necessarily, include a motion prediction algorithm, a proportional-integral-derivative algorithm, a safety detection algorithm, and/or a configuration selection algorithm.

According to an aspect of one preferred embodiment of the invention, the input data may preferably, but need not necessarily, be additionally provided by the database, a network interface device, an input-output device, and/or memory.

According to an aspect of one preferred embodiment of the invention, there is also disclosed a method for controlling an exoskeleton associated with a user. The method comprises the steps (a), (b) and (c). Step (a) involves sensing, by one or more sensors, input data associated with a movement of the user at a predetermined time or time intervals, the input data including movement data and physiological data. Step (b) involves operating a processor to electronically receive the input data from the one or more sensors and execute one or more algorithms to analyze the input data to automatically generate output data having a torque based on the movement of the user. Step (c) involves generating, by a drive force transmission mechanism, the torque for movement of the limb structure about the pivot axis based on the output data from the processor. Thus, according to the invention, the method operatively facilitates the control of the exoskeleton by generating the torque to support the movement of the user.

According to an aspect of one preferred embodiment of the invention, in step (a), the movement data may preferably, but need not necessarily, include angular position, velocity and/or acceleration of the one or more thighs of the user.

According to an aspect of one preferred embodiment of the invention, in step (a), the physiological data may preferably, but need not necessarily, include specific force and/or angular rate of the one or more thighs of the user.

According to an aspect of one preferred embodiment of the invention, the method may preferably, but need not necessarily, further includes a step of electronically storing the input data, movement data, physiological data, and/or output data in a database.

According to an aspect of one preferred embodiment of the invention, in step (b), the one or more algorithms may preferably, but need not necessarily, include a motion prediction algorithm, a proportional-integral-derivative algorithm, a safety detection algorithm, and/or a configuration selection algorithm.

According to an aspect of one preferred embodiment of the invention, the method may preferably, but need not necessarily, further includes a step of receiving input data from the database, a network interface device, an input-output device, and/or memory.

According to an aspect of one preferred embodiment of the invention, in step (b), the execution of the safety detection algorithm determines whether the torque is appropriate and may preferably, but need not necessarily, include a jitter detection substep, a resistance detection substep, an unintended motion detection substep and/or an imbalance substep.

According to an aspect of one preferred embodiment of the invention, in step (b), the execution of the motion prediction algorithm may preferably, but need not necessarily, include a substep of determining a scaling parameter associated with an assistance level for the user.

According to an aspect of one preferred embodiment of the invention, in step (b), the execution of the proportional-integral-derivative algorithm may preferably, but need not necessarily, include a substep of determining one or more tuning parameters associated with the generation of the torque.

According to an aspect of one preferred embodiment of the invention, in step (b), the execution of the motion prediction algorithm or the proportional-integral-derivative algorithm may preferably, but need not necessarily, further include a step of generating a plurality of reference configurations corresponding to the user and a specific movement, each of the plurality of reference configurations including the scaling parameter and the one or more tuning parameters associated with the user and the specific movement.

According to an aspect of one preferred embodiment of the invention, the method may preferably, but need not necessarily, further include a step of generating an input configuration based on the input data, matching a selected one of the plurality of reference configurations corresponding to the input configuration using the configuration selection algorithm, and applying the scaling parameter and the one or more tuning parameters associated with the selected one of the plurality of reference configurations to the generation of the torque.

According to an aspect of one preferred embodiment of the invention, there is disclosed a non-transient computer readable medium on which is physically stored executable instructions. The executable instructions are such as to, upon execution, control an exoskeleton associated with a user. The executable instructions include processor instructions for a processor to automatically: (a) collect and/or electronically communicate input data associated with a movement of the user at a predetermined time or time intervals from one or more sensors to the processor, the one or more sensors including an encoder adapted to receive movement data and an inertial measurement unit adapted to receive physiological data; (b) automatically generate output data including a torque based on the movement of user using one or more algorithms and the input data; and (c) electronically communicate the output data to a drive force transmission mechanism associated with the body portion and the limb structure to generate the torque to move the limb structure about the pivot axis. Thus, according to the invention, the computer readable medium operatively facilitates the control of the exoskeleton by generating the torque to support the movement of the user.

Other advantages, features and characteristics of the present invention, as well as methods of operation and functions of the related elements of the system, method and/or computer readable medium for controlling a lower body exoskeleton, and the combination of steps, parts and economies of manufacture, will become more apparent upon consideration of the following detailed description and the appended claims with reference to the accompanying drawings, the latter of which are briefly described herein below.

### BRIEF DESCRIPTION OF THE DRAWINGS

The novel features which are believed to be characteristic of the device, system, and/or method according to the present invention, as to their structure, organization, use, and method of operation, together with further objectives and advantages thereof, may be better understood from the following drawings in which presently preferred embodiments of the invention may now be illustrated by way of example. It is expressly understood, however, that the drawings are for the purpose of illustration and description only, and are not intended as a definition of the limits of the invention. In the accompanying drawings:

FIG. 1 is a left perspective view of an example exoskeleton apparatus;

FIG. 2 is a right perspective view of the example exoskeleton apparatus;

FIG. 3 is a back view of the exoskeleton of FIGS. 1 and 2;

FIG. 4 is a top view of the exoskeleton of FIGS. 1 and 2;

FIG. 5 is a left side view of the exoskeleton of FIGS. 1 and 2;

FIG. 6 is a perspective view of the exoskeleton of FIGS. 1 and 2 secured to a user;

FIG. 7 is a schematic drawing of a control system for an exoskeleton;

FIG. 8 is a schematic drawing of control architecture for an exoskeleton;

FIG. 9 is a flow diagram of a method of operating the control system of FIG. 7;

FIG. 10 is a flow diagram of a method of operating the control system of FIG. 7; and

FIG. 11 is an illustration of another embodiment of the present invention.

### DETAILED DESCRIPTION OF THE PREFERRED EMBODIMENTS

The description that follows, and the embodiments described therein, may be provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly depict certain embodiments and features of the invention.

The present disclosure may be now described in terms of an exemplary system in which the present disclosure, in various embodiments, would be implemented. This may be for convenience only and may not be intended to limit the application of the present disclosure. It may be apparent to one skilled in the relevant art(s) how to implement the present disclosure in alternative embodiments.

Certain novel features which are believed to be characteristic of a control system for an exoskeleton apparatus which are novel in conjunction with the cooperating environment, according to the present invention, as to their organization, use, and/or method of operation, together with further objectives and/or advantages thereof, may be better understood from the accompanying disclosure in which presently preferred embodiments of the invention are disclosed by way of example. It is expressly understood, however, that the accompanying disclosure is for the purpose of illustration and/or description only, and is not intended as a definition of the limits of the invention.

Exoskeleton

The described embodiments provide a powered exoskeleton structure that preferably supports the hip joints of a user during use. In one embodiment, the exoskeleton may have sensors and a controller that interpret physiological and environmental inputs to allow the user to, for example, stand or walk. Physiological inputs may include, for example, the angular motion for both right and left legs of the user. In a preferred embodiment, the exoskeleton is only activated when the user initiates a movement and/or is in a balanced state.

Actuation of the exoskeleton may be provided by actuators (including, for example, but not limited to electric motors, which may be stepped down with transmissions at each hip joint). It may generally be understood by a person skilled in the relevant art that the term “actuator” is a mechanical or electro-mechanical device adapted to provide controlled and sometimes limited movements or positioning which are operated electrically, manually, or by various fluids such as air, hydraulic, etc. Power, for electrically operated actuators, is preferably provided by an on-board battery pack. In preferable embodiments of the present invention, the actuator includes the X-Series Actuator®—such as the XB-9 configuration—offered by HEBI Robotics (Pittsburgh, Pa.).

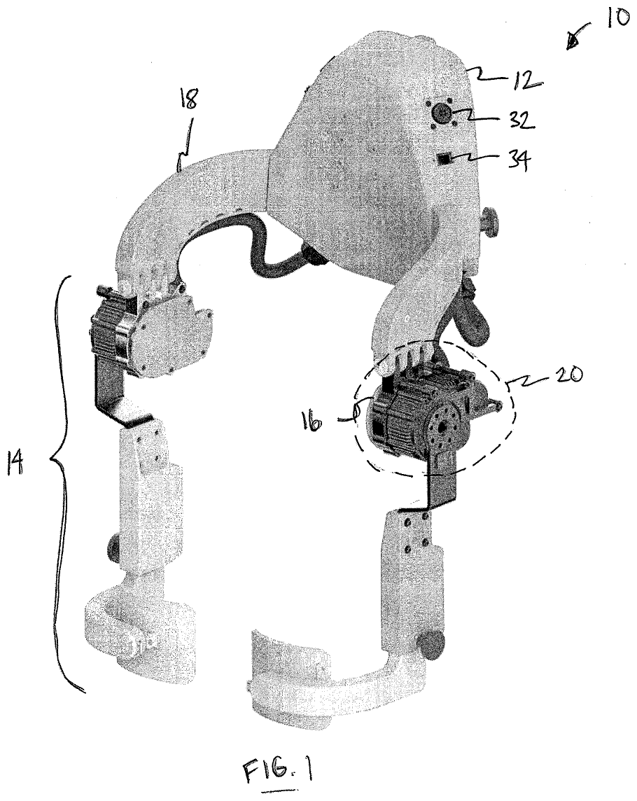

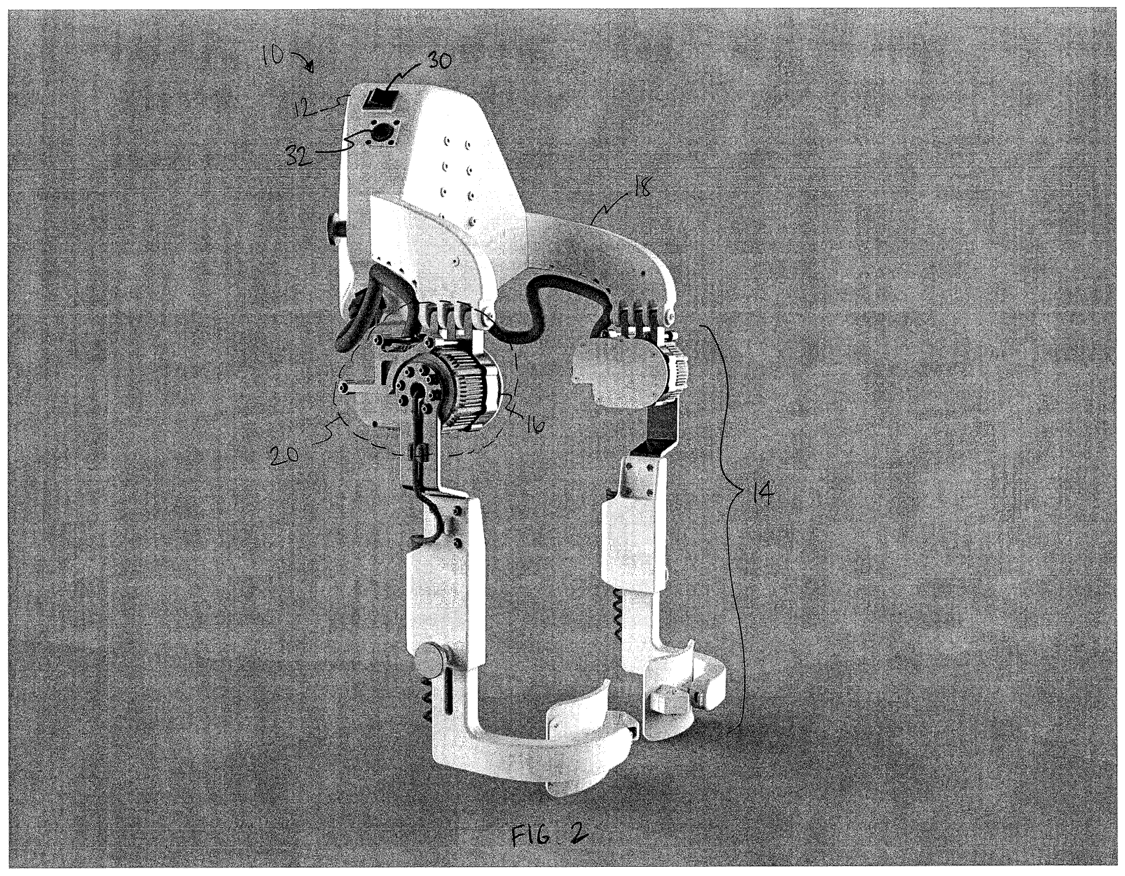

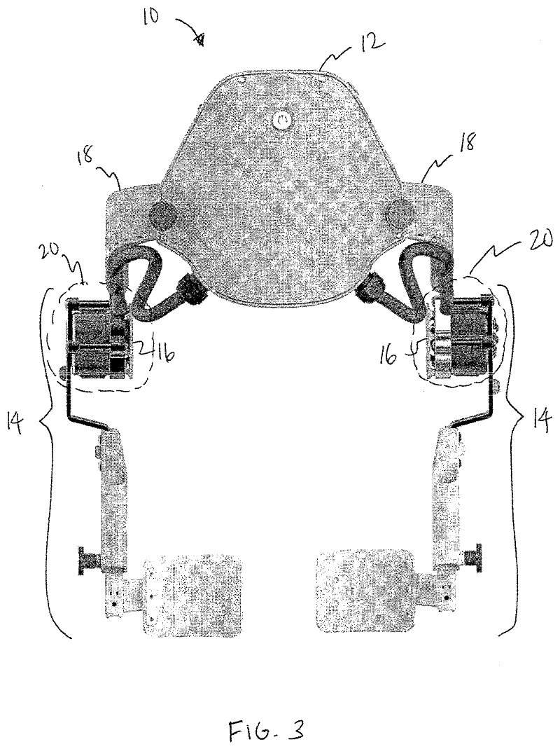

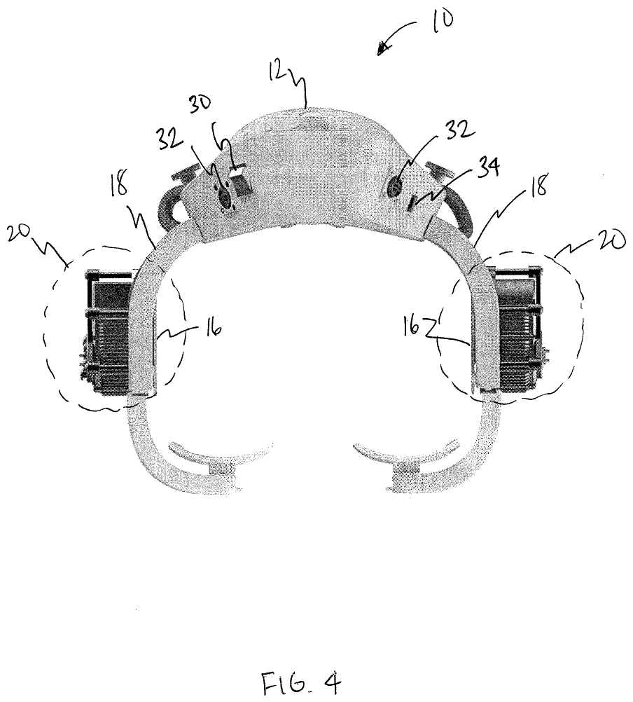

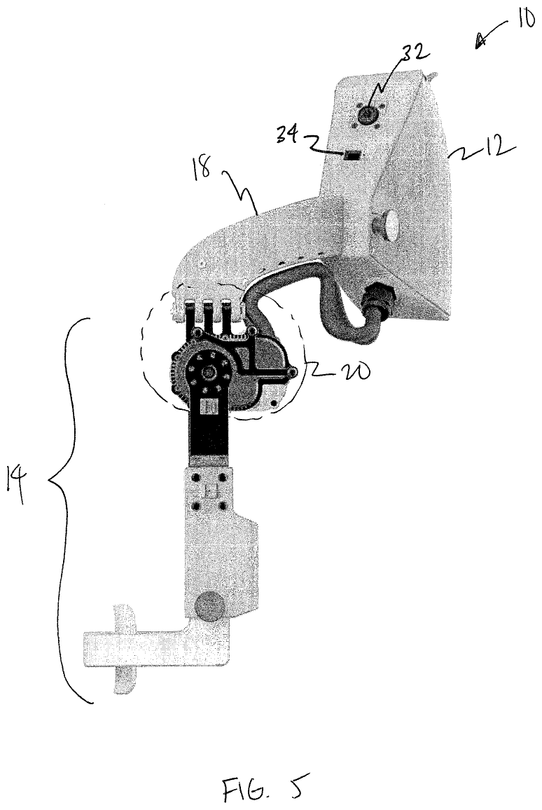

Referring now to FIGS. 1 to 5, an example embodiment of exoskeleton 10 is shown. In the embodiment shown, the exoskeleton apparatus is an exoskeleton for both legs of a user. In alternate embodiments, the exoskeleton apparatus may be a partial exoskeleton for only one hip joint of one leg. For example, a hip joint actuator may be deactivated if a hip joint of the user does not require any assistance, facilitating movement of the hip joint by user force only. In a preferred embodiment, the one or more actuators of the exoskeleton work independently based on the reaction and/or response of the user's right and left hip.

It will be appreciated that the exoskeleton may be provided with only one hip joint structure. For example, a user may only have one hip joint that has impaired movement or control of movement. It will also be appreciated that the exoskeleton may be designed for a user who has difficulty with the movement of only one hip joint. In such a case, the exoskeleton may be configured so as to provide motorized assist for only that joint.

In the illustrated embodiment, the exoskeleton 10 includes a body portion or support structure 12 that is moveably connected to two limb structures 14. Limb structure 14 may be moveably and drivingly connected to body portion 12. As exemplified, limb structures 14 are of the same construction. However, it will be appreciated that limb structures 14 may differ. In preferable embodiments, the support structure 12 includes a power switch 30 for turning the exoskeleton 10 on or off and a charging port 32 adapted to charge an onboard energy storage member (not shown). In preferable embodiments, an interface 34 is provided to facilitate wired communication (e.g., a LAN port) between a processor of the exoskeleton 10 and an external device (e.g., a computer for data collection).

Each of limb structure 14 and body portion 12 may be formed of a metal, metal alloy, plastic, composite or another suitable material, or combinations thereof. Each component may be formed of a single contiguous element, or may comprise multiple elements coupled together.

In some embodiments, body portion 12 includes a hip portion 16 and a waist portion 18, which are generally coupled together. Body portion 12 may also have hip rests (not shown) and a back rest (not shown) provided thereon for user comfort. Hip rests and back rest may be provided in various suitable configurations. Extruded foam or another suitable material may be used to form the hip and back rests. Alternately, these may be rigid members (e.g., formed of a metal, metal alloy, plastic, composite or another suitable material) which may be padded (e.g., foam or other deformable material). It will be appreciated that the body portion 12 may be used by itself. It will also be appreciated that the different aspects disclosed herein may be used without a body portion 12 or any body portion known in the art.

In some embodiments, limb structure 14 may provide a support structure upon which one or more motors (not shown) are provided. Preferably, a motor is provided for each joint that is motorized.

An onboard energy storage member may be provided to provide power for the motors. Any energy storage member may be provided and the energy storage member may be provided at any location on the exoskeleton or it may be remotely positioned to the exoskeleton. For example, a power pack may be carried by a user and may have a cord that plugs into the exoskeleton. The energy storage member may comprise one or more batteries. Batteries (not shown) may be provided on the limb structure 14. In other embodiments, one or more batteries (not shown) may be provided on the body portion 12. It will be appreciated that, as exemplified, each motor may be provided with its own battery. An advantage of this design is that the weight of the batteries is more evenly distributed. Alternately, a central power pack may be provided which is connected to each motor.

The provision of elements such as motors and batteries on the limb structure 14, proximal to the hip joint of the user, allows for the reduction of the mass moment of inertia of the lower portion of the limb structure 14. Reducing the moment of inertia correspondingly reduces the stress on a user's joints that would otherwise result from a heavier lower portion of the limb structure.

Preferably, the limb structure 14 is drivingly connected to the exoskeleton 10 such that the limb structure 14 may have a mount, and a drive force transmission mechanism 20 may be provided to drivingly connect a motor to an adjacent portion of the exoskeleton 10 on the other side of a joint. For example, an upper end of limb structure may have a drive force transmission mechanism 20 to drivingly connect a motor (not shown) to the limb structure 14. Preferably, the portions of the exoskeleton 10 are pivotally connected together. The mount preferably includes a pivot (not shown) having a pivot axis A, as shown in greater detail in FIG. 1. Pivot may preferably comprise a bearing to facilitate rotational motion of the limb structure 14 relative to the exoskeleton 10 about pivot axis A.

A limb structure cover 24 may be provided to shield portions of exoskeleton 10 from dust, debris and/or other contaminants, and also to protect moving elements of exoskeleton 10 from external objects. Upper limb cover 24 may be formed of a metal, metal alloy, plastic, composite or another suitable material.

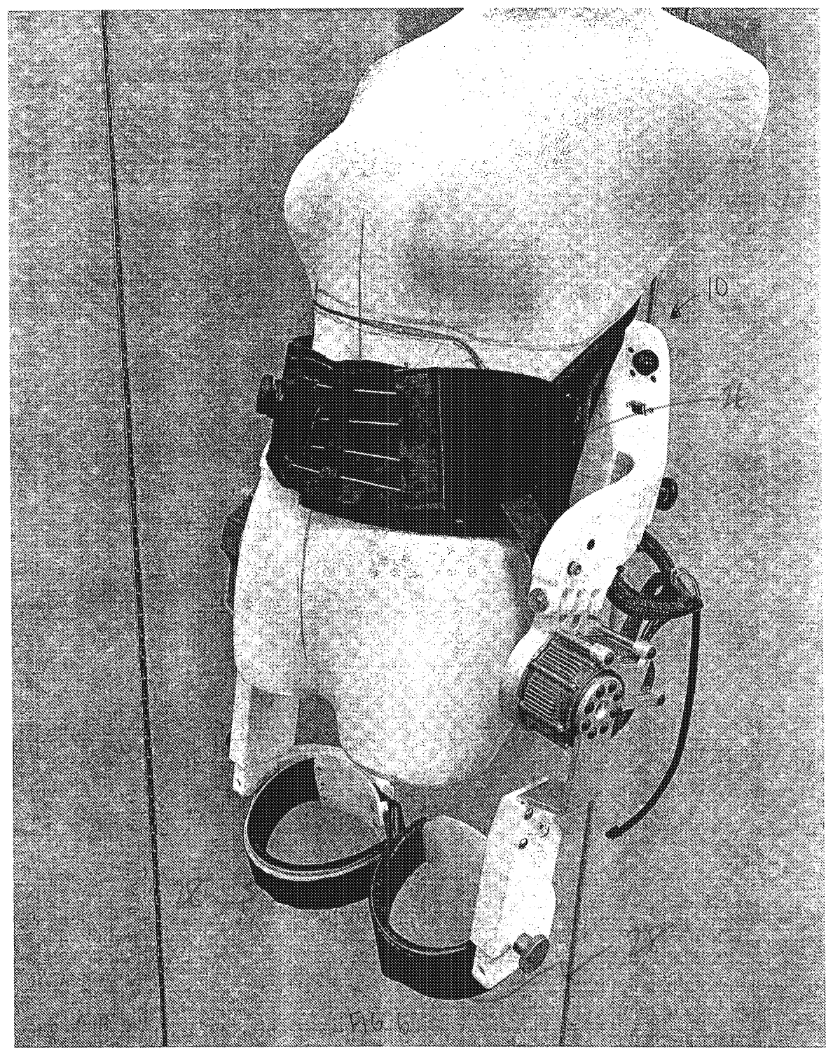

FIG. 6 depicts a perspective view of the exoskeleton 10 worn by a user. The exoskeleton 10 is releasably secured to the user by an adjustable abdominal support 26 and an adjustable thigh support 28 for each leg. In preferred embodiments, the exoskeleton 10 is adapted (e.g., using slots) to receive straps (i.e., abdominal support 26 and thigh support 28), preferably a Velcro adjustable, soft and cushioned surface, to comfortably secure the user to the exoskeleton 10.

While the described embodiments for the exoskeleton generally relate to an exoskeleton for the hip joints of a user, an exoskeleton for other joints may similarly be provided for other body joints (e.g., the knees, ankles, elbows, and fingers) in accordance with an alternate embodiment of the present invention.

Control System

The control system preferably controls movement of the exoskeleton. In particular, the control system may include one or more modules for monitoring various sensors provided on the exoskeleton, and controlling actuators to cause movement of the exoskeleton.

As the term “module” is used in the description of the various embodiments, a module includes a functional block that is implemented in hardware or software, or both, that performs one or more functions such as the processing of input data to produce output data. As used herein, a module may contain sub-modules that themselves are modules.

Embodiments of the control system described herein may be implemented in hardware or software, or a combination of both. These embodiments may be implemented in computer programs or algorithms executing on programmable computers, each computer including at least one processor, a data storage system (including volatile memory or non-volatile memory or other data storage elements or a combination thereof), and at least one communication interface.

Each program may be implemented in a high level procedural or object oriented programming or scripting language, or both. Alternatively, the programs or algorithms may be implemented in assembly or machine language, if desired. The language may be a compiled or interpreted language. Each such computer program may be stored on a non-transitory computer-readable storage medium (e.g., read-only memory, magnetic disk, optical disc). The storage medium so configured causes a computer to operate in a specific and predefined manner to perform the functions described herein.

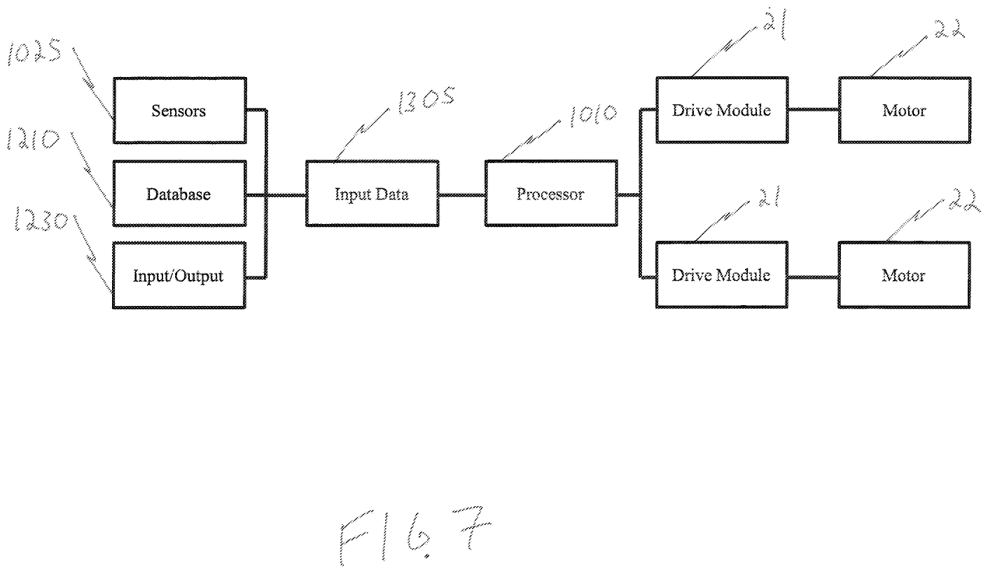

Referring now to FIG. 7, there is shown a schematic of an example control system 1000 for an exoskeleton apparatus, such as exoskeleton 10 in FIGS. 1-6, for example. Some parts of the system 1000 depicted in FIG. 7 may be provided at a remote location.

Control system 1000 includes a processor 1010, memory 1015, one or more power sources (not shown), one or more sensors 1025, one or more motor drive modules 21 and one or more drive motors 22. The one or more sensors 1025, are preferably physically coupled to the exoskeleton, and in communication with the processor 1010.

The one or more sensors 1025 may be configured to detect a physiological characteristic associated with the exoskeleton and/or user. The physiological characteristic may include a positional characteristic to determine the desired angular position of the user's thigh. In a preferable embodiment, the one or more sensors 1025 includes a sensor adapted to measure the positional characteristic (e.g., an encoder), including mechanical motion, to generate movement data (or positional data) in response to motion (e.g., position, velocity, direction). In a preferred embodiment, the one or more sensors 1025 include a sensor adapted to measure and/or determine the physiological characteristic including a body's specific force and/or angular rate using a combination of accelerometers, gyroscopes and/or magnetometers to generate physiological data (e.g., an inertial measurement unit or “IMU”). It will be appreciated that, in some embodiments, more than one of each type of sensor may be provided and used. For example, encoders may be associated with each hip joint actuator. In addition, IMUS may be placed in each hip joint (e.g., to detect the motions performed in any direction other than flexion/extension).

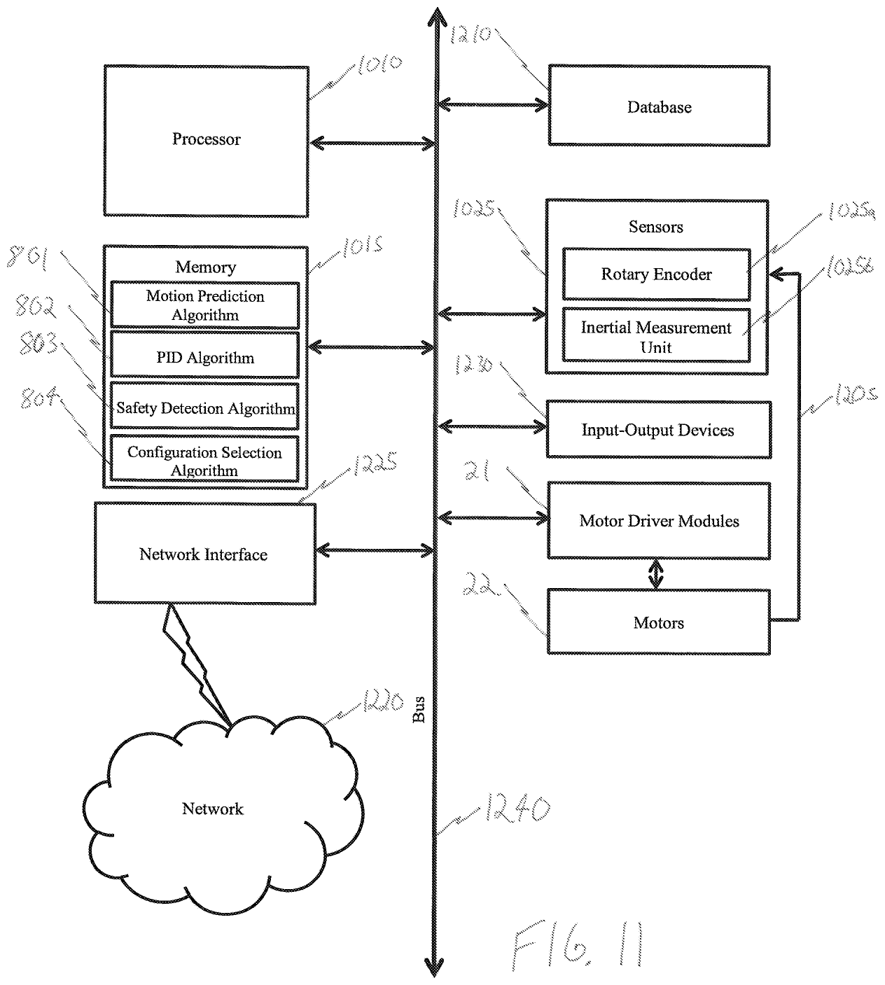

Processor 1010 may be a microcontroller, an embedded processor, a field programmable gate array (“FPGA”) or other suitable microprocessor. Preferably, the processor 1010 is operatively encoded with one or more algorithms (shown schematically in FIG. 11 as being stored in the memory 1015), which provide the processor 1010 with, for example, a motion prediction algorithm 801 to provide motion prediction logic to enable the processor 1010 to assess input data received from the one or more sensors 1025 as well as any additional data that may be associated with the exoskeleton 10. In operation, processor 1010 receives input data from the one or more sensors 1025, database 1210, network interface device 1225, input-output devices 1230, and/or memory 1015 which may be at a predetermined time or time intervals. The input data is applied and/or implemented by the execution of certain algorithms (e.g., motion prediction algorithm 801) by the processor 1010 to generate output data, that includes the desired hip joint torque for the motors 22 via the one or more motor drive modules 21.

Preferably, processor 1010 is adapted to monitor the one or more sensors 1025 and implement control actions (e.g., engage the motors 22 via the one or more motor drive modules 21) in real-time. As the exoskeleton 10 preferably operates with battery power, processor 1010 can be selected to have a low power consumption.

Preferably, processor 1010 is operatively coupled to motor drive modules 21, which control the operation of drive motors 22. In some embodiments, the motor drive modules 21 include an integrated circuit driver. One motor drive module 21 may control multiple drive motors 22. However, in practice this arrangement may cause a high amount of power usage for a single integrated circuit, risking “burning out” the circuit. Accordingly, in preferable embodiments, an individual motor drive module 21 may be associated with each drive motor 22. Each drive motor 22 preferably drives the operation of a hip joint of the exoskeleton 10, and therefore each motor drive module 21 can control the movement of the joint (i.e., pivoting of limb structure 14 about pivot axis A), under the direction of the processor 1010.

In one example embodiment, exoskeleton 10 has two drive motors 22. Each motor is a 48V motor drawing approximately 1 A while in use. Motor drive modules 21 have a current capacity of approximately 25 A. Control system 1000, and processor 1010, operates at 5V. The battery has cell voltages of approximately 3.7V and a combined capacity of about 20 Ah, requiring approximately 15 battery cells. Given this configuration, exoskeleton 10 has a run-time of approximately two (2) hours with a 100% duty cycle.

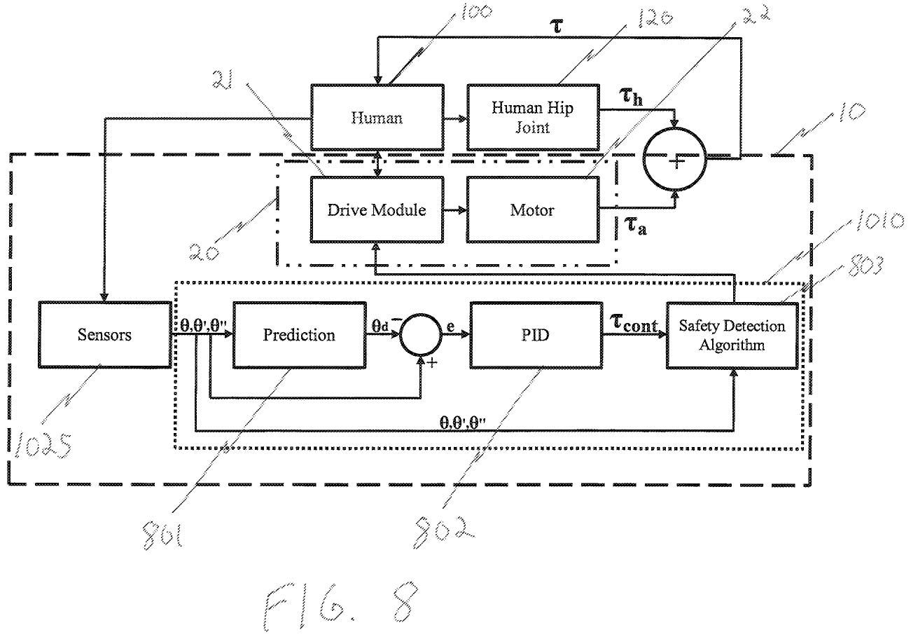

Referring now to FIG. 8, there is shown a control architecture for the exoskeleton 10. It may be understood that during operation of the exoskeleton 10, both the human hip joint 120 and actuator hip joint 20 (or drive force transmission mechanism 20) should preferably be of comparable angles relative to each other such that should the user 100 send a command to rotate his or her hip joint 120, the exoskeleton 10 will also rotate via the actuator hip joint 22. The horizontal line separates the human 100, denoted as the portion above the line “A”, and exoskeleton 10, denoted as the portion below the line “B”, components of the control system.

It may be understood that in isolation, the human component of the control system approximates a normal control loop for natural human motion, such that a torque τₕ is initiated by the person 100 causing generation of force by the joint 120. Similarly it may be understood that a torque τₐ may be initiated by the exoskeleton 10 and/or motor 21 causing a generation of force by the actuator 22. It may be understood that during operation of the exoskeleton 10 the torques τₕ and τₐ are added together to exert a total torque T on the person 100 using/operating the exoskeleton 10 and/or the exoskeleton 10 itself.

In accordance with a preferred embodiment of the present invention, the exoskeleton 10 is adapted to measure the hip joint angle and any change in the angle over time, as shown in FIG. 8. In a preferred embodiment, one or more sensors 1025 generate input data, preferably comprising movement data of the actuator 22, which is associated with and/or approximates the position of the human hip joint 120. Preferably, movement data includes the current angular position θ(t), velocity θ′(t) and acceleration θ″(t) of a user's thigh; however, a person skilled in the relevant art may appreciate that second through n^{th} order derivatives may be used depending on accuracy and processing power requirements. Processor 1010 preferably analyzes the input data generated by the one or more sensors 1025 to predict the desired change in angle of the user's hip 120 based on prediction algorithm 801, θ_{d}. The predicted desired change in angle θ_{d} is preferably added to the current hip angle θ and inputted to a controller, such as a proportional-integral-derivative (“PID”) controller 802 (alternatively “PID algorithm 802”), to determine a torque, τ_{cont} to achieve the desired angle. In preferred embodiments of the invention, the PID algorithm 802 provides control loop feedback or continuous modulated control logic to enable the processor 1010 to continuously calculate an error value as to the difference between a desired set point and a measure process variable and apply a correction based on proportional, integral, and derivative terms. In preferred embodiments, before applying the torque, a further safety detection algorithm 803 is executed, which provides the processor 1010 with safety detection logic to determine the appropriateness of the torque τ_{cont} for the given situation and to prevent unintended actions and/or unbalancing/unsettling behaviours.

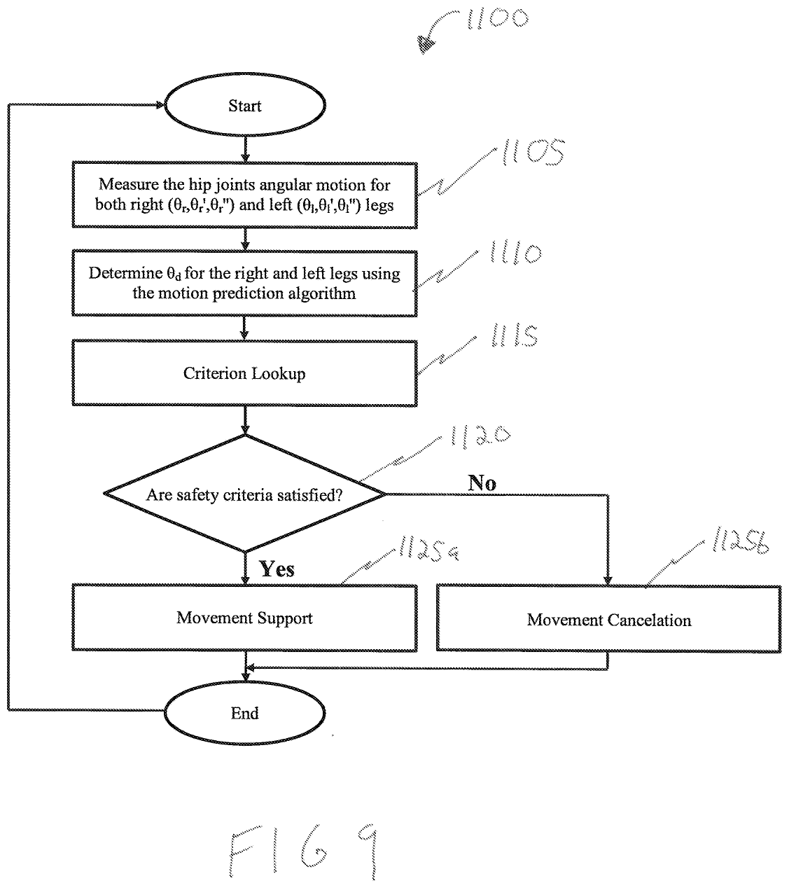

Referring now to FIG. 9, there is shown a flow diagram of an example method of controlling an exoskeleton in accordance with a preferred embodiment of the invention. Method 1100 may be carried out, for example, by the processor 1010 of control system 1000 (as shown in FIG. 11). Preferably, the method 1100 is adapted to control the exoskeleton to assist the user's hip joints in order to facilitate stable walking on level ground. Preferably, the method 1100 is based on the user's reaction (or intended movements) in combination with input data, in contrast to prior art methods that may have been based on gaits, or biosignals of the user (e.g., EMG sensors). The method 1100 is preferably adapted to prevent driving the user to any unintended motion and/or restricting the user's movements.

As shown in FIG. 9, the method 1100 includes the following steps, among others: a start step; a measurement step 1105 including the reception of input data from one or more sensors; a prediction step 1110 including the determination of a user desired angle based on a prediction algorithm; a safety criteria lookup step 1115; and a step 1120 of querying if the safety criteria is within the predetermined target parameters. In the event that the query is answered in the affirmative (i.e., if the safety criteria is within the predetermined target parameters), the method 1100 proceeds to a movement support step 1125a of generating a torque to facilitate the desired movement of the user. If answered in the negative, the method 1100 proceeds to a movement cancellation step 1125b which includes cancelling the torque force or generating a non-zero torque to prevent and/or eliminate jittering, unintended and/or resistive motions. An end step concludes the method 1100, which is preferably continuously repeated by, for example, the PID algorithm during the operation of the exoskeleton.

Method 1100 may be initiated by the user placing the control system and exoskeleton in an active mode. For example, the active mode may be enabled by the user activating a patient input interface such as a switch or button provided on the exoskeleton or via a remote interface (e.g., using a smartphone or tablet).

At step 1105, the one or more sensors (e.g., encoders) on the hip joint actuators are utilized to measure the current angular position θ(t), velocity θ′(t) and acceleration θ″(t) of a user's thigh. The encoder generates input data (specifically, movement data) based on the respective measurements, including position information, for each hip joint. Preferably, the input data is sent to the processor to determine θ_{d} for the right and/or left legs using the motion prediction algorithm (as shown in FIG. 8).

At step 1110, using a constant angular acceleration assumption within each time step (e.g., Δt<10 msec), the following prediction algorithm is preferably applied to predict the desired angular position of the user's thigh:

θₚ(t)=θ(t)+\dot{θ}(t)Δt+0.5 \ddot{θ}(t)Δt² (Equation 1)

Persons skilled in the relevant art may appreciate that Equation 1 is a Taylor series approximation of the hip joint movement function. It may be appreciated that other algorithms may be used to determine an estimated hip angle at a predetermined future time or time intervals. In a preferred embodiment, the predetermined time intervals are approximately based on the processing time of the control system.

Persons skilled in the relevant art will appreciate that θₚ is a predicted hip angle based on the kinematics at time t. For people with relatively low muscle function predicted, deflection θₚ may be small, due to physical inability, even though a larger deflection is desired. In preferred embodiments, the predicted deflection is scaled to accommodate the degree of muscle function. The desired angular position is determined as:

$${θ}_{d} = {θ}_{p} ( t ) + γ \times \vert {θ}_{p} ( t ) \vert \times \frac{\vert {θ}_{max} - \vert θ ( t ) \vert \vert}{{θ}_{max}} \times sgn ( \dot{θ} ( t ) ) \qquad ( Equation 2 )$$

where θₘₐₓ is maximum flexion range of hip joint (i.e., around 45°), and sgn(.) is a sign function. Persons skilled in the art may understand that other prediction algorithms may be used which have additional features including, but not limited to, those which may provide for non-linear scaling.

In preferred embodiments, γ≥0 is the scaling parameter used to determine the assistance level and is additionally dependent on the conditions of the environment (e.g., ascending or descending) and/or human specification (e.g., degree of muscle function, etc.). Δt is the time between measuring angular motion and applying the corresponding control signal.

At steps 1115 and 1120, safety criteria for the exoskeleton includes, for example, the application of predetermined target parameters and/or conditions to avoid jittery, unintended, and/or resistive motions from the actuators. Step 1115 preferably includes a series of individual safety criteria sub steps (as set out in Table 1), which may be stored in the database and/or a safety database. Any number and arrangement of substeps may be used to determine the target operating parameters of the exoskeleton. Each safety substep is preferably chosen so that if the exoskeleton fails any one of the predetermined safety criteria substeps at step 1120, the method 1100 proceeds to step 1125b whereby, for example, no torque will be applied by the actuator (τ_{actuator}=0); or step 1125a whereby, for example, if all predetermined safety criteria substeps required are passed a torque is applied (τ_{actuator}=τ_{cont}) by the motor. A safety report may be generated (not shown) disclosing, for example, details of any failures of the predetermined safety criteria substeps. Safety criteria substeps may be included in profiles (or configurations) provided hereinbelow, or alternatively be preconfigured and stored in a local or remote database.

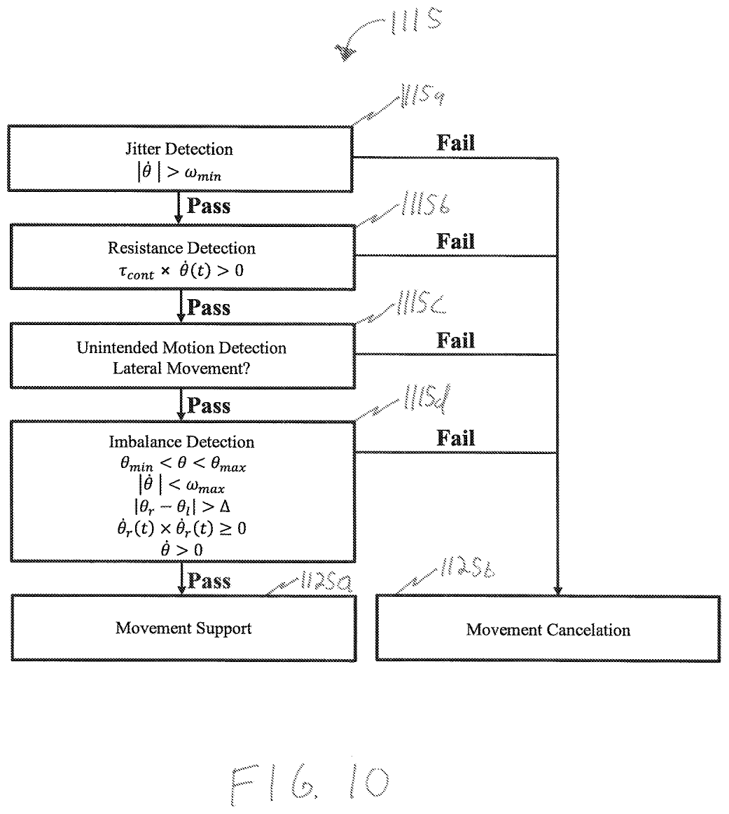

In a preferred embodiment of the present invention as shown in FIG. 10, the safety criteria lookup step 1115 includes substeps 1115a-d provided to prevent the torque generated by the actuators from causing jittering and/or unintended/resistive motions. The substeps 1115a-d include:
(a) a jitter detection substep 1115a to provide no assistance (i.e., actuators do not generate any torque) when the rate of rotation of the user's hip is below a threshold using a low pass filter that suppresses the actuator torque command when fluctuating below a specific amount which may be predetermined;
(b) a resistance detection substep 1115b to check that the power input from each hip joint actuator (i.e., computed as P_{cont}=τ_{cont}×\dot{θ}(t)) is always non-negative, and, if P_{cont}<0 is detected, then the actuator does not apply any torque to the corresponding limb structure;
(c) an unintended motion detection substep 1115c to detect any motions that occur in any direction other than flexion/extension (e.g., lateral movement) by using an IMU (i.e., placed in the hip joints); and
(d) an imbalance detection substep 1115d to prevent unbalancing and/or exceeding the range of motion by observing the user's motion.

Table 1 is a safety command table that sets out the failure criteria for safety criteria sub steps 1120a, 1120b, and 1120d.

TABLE 1

| | Command (from | |
|---|---|---|
| Condition | actuator) | Reason |
| \|\dot{θ}\| < ωₘᵢₙ | no assistance (τₐ = 0) | Switching phase (prevents jittery |
| | | motion) |
| P_{cont} = τ_{cont} · | no assistance (τₐ = 0) | Removes resistance |
| \dot{θ}(t) | | |
| \|\dot{θ}\| > ωₘₐₓ or | no assistance (τₐ = 0) | Very quick motion (powering |
| θ > θₘₐₓ | | the hip might unbalance user) |
| \|θᵣ − θₗ\| > Δ & | no assistance (τₐ = 0) | The angle between right and left |
| \dot{θ}ᵣ(t) · \dot{θ}ₗ(t) ≤ 0 | | hips is too much (might |
| | | unbalance user) |
| θ < θₘᵢₙ & \dot{θ} < | no assistance (τₐ = 0) | Too much extension force might |
| 0 | | unbalance user or might lead to |
| | | jittery motion |

In preferable embodiments, (θₘᵢₙ, θₘₐₓ), (ωₘᵢₙ, ωₘₐₓ) as well as Δ are configured to the minimum and maximum range of motion, range of speed for a user's hip joint, and maximum angle between the right and left thighs of the user, respectively, that is appropriate for maintaining balance (e.g., (θₘᵢₙ, θₘₐₓ) is preferably about (20°, 45°), (ωₘᵢₙ, ωₘₐₓ) is preferably about (0.3 rad/sec, 3 rad/sec) and Δ is preferably about (5°)).

In an embodiment, failure criteria may alternatively include any conditions under which non-desired actions are taken by the exoskeleton, including both applying and not applying a torque to the actuator. Persons skilled in the relevant art may recognize that the success criteria in FIG. 10 is nonfulfillment of the failure criteria described above. Failure criteria may be alternatively configured to instruct one or more actuators to generate non-zero torques, which may change other parameters, set an alternate configuration profile, and/or provide a torque greater than τ_{cont}.

Referring to FIG. 9, at step 1125a, the motor drive module 21 determines a hip joint torque of each leg, τ_{cont}, so that the thigh angle, θ, approximately tracks the desired angle θ_{d}.

Error is defined as:

e=θ−θ_{d}

The joint control is preferably defined as:

τ_{cont}=−(kė+k′e)

where k, k′>0 are preferably tuning parameters for the PID controller 802 (i.e., positive constants that should be tuned to improve the controller performance).

In some embodiments of the present invention scaling parameter γ, and tuning parameters k and k′ may be calibrated for a specific user and/or task. Similarly, should alternate prediction algorithms be used, parameters therein may optionally be calibrated for specific users and/or tasks. In some embodiments, these parameters may optionally be grouped for specific tasks, events, and/or individuals so as to generate a reference configuration that preferably contains sufficient information to optimize movement support.

The reference configurations may be predetermined, for example, by comparing the movement of an able-bodied individual and a user in various scenarios to determine the amount of support required. Alternately, a reference configuration may be determined for a user in a particular situation through trial-and-error methods. Reference configurations may be provided in a local database or in a remote database uploaded to the processor using a network. Preferably, each reference configuration corresponds to a “scenario” and/or a specific “user” that governs the performance of the exoskeleton based on input data (e.g., from the one or more sensors).

In an embodiment of the present invention, the processor receives input data from the one or more sensors to generate an input profile (or “input configuration”) at a particular moment in time. The input configuration may preferably be associated with a specific reference configuration (e.g., walking slowly on level ground). Each of the reference configurations has one or more corresponding parameters (e.g., scaling parameter γ, and tuning parameters k and k′) which the processor 1010 uses to implement the prediction algorithm 801.

In an embodiment of the present invention the control system preferably detects physiological characteristics associated with the exoskeleton, using the one or more sensors (e.g., IMU) coupled to the exoskeleton. Each sensor preferably performs a measurement (e.g., angle, force, acceleration, etc.) and generates input data (e.g., physiological data or inertial measurement unit data) that includes a representation of the respective measurement for a given user. The input data generated by each sensor is transmitted to the processor to generate an input configuration for the current input data.

Upon receiving the input configuration, the processor automatically executes a configuration selection algorithm to determine an appropriate reference configuration. Alternatively, the user may select a predetermined reference configuration. Processor preferably determines if the input data included in the input configuration is within the expected values for the reference configuration and, if they are, continues implementing the associated parameters in the motion prediction algorithm.

Preferably, the processor 1010 associates the input configuration to a reference configuration (from a plurality of reference configurations) stored in a memory or local and/or remote database by determining if the values included in the input configuration matches any reference configuration. For a match to occur, the input data must be within the range of expected or predetermined values specified in the reference configuration. In some embodiments of the present invention, not all of the sensors need be considered in every reference configuration.

If no match is found between the input configuration and the reference configuration, a delay may be implemented before re-initiating the configuration selection algorithm. The delay may be minimal, for example on the order of milliseconds, such that the configuration selection algorithm executes during a sampling interval of the plurality of sensors, or during some number of clock cycles of processor 1010. Alternatively a default reference configuration may be loaded from the database.

In an alternate embodiment of the present invention the selected reference configuration may be chosen by a user. User reference configuration selection may, but not necessarily, be accomplished using a mobile device, internet connected device, or directly on the device itself through an interface.

In an alternate embodiment of the present invention only a single reference configuration may be provided.

FIG. 11 schematically illustrates, among other things, that the control system 1000 includes a processor 1010, a computer readable medium (e.g., an onboard processor-readable memory, for example, a read-only memory (ROM) or dynamic random access memory (DRAM) which communicate with each other via a bus 1240) 1015 local to the processor 1010, a network interface 1225 (preferably including transmitter-receiver functions and adapted for use with a network 1220), a database 1210, one or more sensors 1025 (including a rotary encoder 1025a, an IMU 1025b, etc.), input-output components 1230, a motor drive module 21, a motor 22, and a bus 1240.

As shown in FIG. 11, the control system 1000 includes the motion prediction algorithm 801, PID algorithm 802, and/or safety detection algorithm 803 which causes the processor 1010 to perform any one or more of the instructions discussed herein. The control system 1000 may include additional or different components, some of which may be optional and not necessary to provide aspects of the present disclosure. The control system 1000 may be connected to other computing devices in a LAN, an intranet, an extranet, or the Internet. The control system 1000 may operate in the capacity of a server or a client computing device in client-server network environment, or as a peer computing device in a peer-to-peer (or distributed) network environment. Further, while only a single processor 1010 is illustrated, the term “processor” shall also be taken to include any collection of computing devices that individually or jointly execute a set (or multiple sets) of instructions to perform any one or more of the methodologies discussed herein.

Control system 1000 may further include a network interface device 1225, one or more sensors 1025—such as an Inertial Measurement Unit 1025b and/or a rotary encoder 1025a—and one or more input-output devices 1230 (e.g., a keyboard and touch screen).

Control system 1000 may also include motor drive modules 21 for providing control instructions to motors 22. Preferably the motor drive modules 21 are operatively connected to the processor 1010 such that the exoskeleton is actuated by the motors 22 based upon the output data from the execution of the motion prediction algorithm 801, PID algorithm 802, and/or safety detection algorithm 803. Preferably, the motors 22 or joints to which the motors 22 actuate are associated with the rotary encoder 1025a, depicted in FIG. 11 by arrow 1205, to allow the rotary encoder 1025a to measure the angle and associated time dependent derivatives thereof of the exoskeleton joint being actuated. Rotary encoders 1025a preferably provide such input data to processor 1010 through a bus 1240 allowing the execution of instructions 801, 802, 803 and/or exoskeleton control method 1100, preferably including the evaluation of future desired torques and the detection of any nonfulfillment of safety criteria substeps.

In an embodiment of the present invention, the system 1000 may be entirely or partially replicated remotely (e.g., cloud computing). Preferably, the remote system includes one or more remote processors capable of at least partially executing method 1100 such that input data may be uploaded to the remote processor and output data downloaded to the exoskeleton 10 for further processing or sent directly to the motor drive modules 21 to generate torque via the motors 22.

Input data 1305, preferably including data generated by rotary encoder 1025a and/or IMU 1025b, may be stored in the database 1210 for future recall, review (e.g., troubleshooting or generating reports), and/or analysis by the processor 1010. Input data 1305 generated by rotary encoder 1025a and/or IMU 1025b may also be further transmitted over network 1220 via network interface device 1225 to facilitate remote monitoring of the exoskeleton and/or data storage. Conversely, input data 1305 may also be received over network 1220 via network interface device 1225 and stored in the database 1210 local to the exoskeleton for future recall, review (e.g. troubleshooting or generating reports), and/or processing by processor 1010.

The computer readable medium 1015, shown in FIG. 11, stores executable instructions (i.e., motion prediction algorithm 801, PID algorithm 802, safety detection algorithm 803) which, upon execution, analyzes input data, preferably received from the one or more sensors 1025, the input-output components 1230 and/or the database 1210. The input data may, but not necessarily, include safety criteria substeps 1115a-d and/or profiles. The executable instructions 801, 802, 803 provide logic to the processor 1010 for the performance of steps and/or to provide functionality as otherwise described above and elsewhere herein. The processor 1010 encoded by the computer readable medium 1015 are such as to perform an analysis on the input data to, for example, determine the desired angular position of the user's thigh, and transmit output data to the motor drive modules 21 and/or the database 1210. Thus, according to the invention, the computer readable medium 1015 facilitates the use of the processor 1010 to operatively facilitate the analysis of the input data. In alternate embodiments, the motion prediction algorithm 801, PID algorithm 802, safety detection algorithm 803 may be transmitted or received over network 1220 via the network interface device 1225.

Thus, the system 1000, method 1100, and computer readable medium 1015 operatively facilitate the determination of the desired angular position of the user's thigh to assist the hip joints for walking on ground level based on the user's reaction.

The database 1210 includes, and is regularly updated with, the input data 1305 (e.g., movement data such as from an encoder, inertial measurement unit data, etc.), output data, safety criteria substeps 1115a-d, target parameters, safety reports and/or profiles. The database 1210 may be located behind a firewall relative to the network 1220. Persons of ordinary skill in the art will appreciate that references herein to the database 1210 may include, as appropriate, references to: (i) a single database located local to the exoskeleton; (ii) a single database located at a facility (e.g., remote to the exoskeleton); and/or (iii) one or more congruent and/or distributed databases such as, for example, also including one or more sets of congruently inter-related databases—possibly distributed across multiple facilities. In some embodiments, for example, the safety criteria substeps 1115a-d and/or profiles may be transmitted or received over network 1220 via the network interface device 1225.

The present disclosure may be described herein with reference to system architecture, block diagrams and flowchart illustrations of methods, and computer program products according to various aspects of the present disclosure. It may be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It may also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In this disclosure, a number of terms and abbreviations may be used. The following definitions and descriptions of such terms and abbreviations are provided in greater detail.

It may be further generally understood by a person skilled in the relevant art that the term “downloading” refers to receiving datum or data to a local system (e.g., an exoskeleton apparatus) from a remote system (e.g., a client) or to initiate such a datum or data transfer. Examples of a remote systems or clients from which a download might be performed include, but are not limited to, web servers, FTP servers, email servers, or other similar systems. A download can mean either any file that may be offered for downloading or that has been downloaded, or the process of receiving such a file. A person skilled in the relevant art may understand the inverse operation, namely sending of data from a local system (e.g., an exoskeleton apparatus) to a remote system (e.g., a database) may be referred to as “uploading”. The data and/or information used according to the present invention may be updated constantly, hourly, daily, weekly, monthly, yearly, etc. depending on the type of data and/or the level of importance inherent in, and/or assigned to, each type of data. Some of the data may preferably be downloaded from the Internet, by satellite networks or other wired or wireless networks.

Elements of the present invention may be implemented with computer systems which are well known in the art. Generally speaking, computers include a central processor, system memory, and a system bus that couples various system components including the system memory to the central processor. A system bus may be any of several types of bus structures including a memory bus or memory controller, a peripheral bus, and a local bus using any of a variety of bus architectures. The structure of a system memory may be well known to those skilled in the art and may include a basic input/output system (“BIOS”) stored in a read only memory (“ROM”) and one or more program modules such as operating systems, application programs and program data stored in random access memory (“RAM”). Computers may also include a variety of interface units and drives for reading and writing data. A user of the system can interact with the computer using a variety of input devices, all of which are known to a person skilled in the relevant art.

One skilled in the relevant art would appreciate that the device connections mentioned herein are for illustration purposes only and that any number of possible configurations and selection of peripheral devices could be coupled to the computer system.

Computers can operate in a networked environment using logical connections to one or more remote computers or other devices, such as a server, a router, a network personal computer, a peer device or other common network node, a wireless telephone or wireless personal digital assistant. The computer of the present invention may include a network interface that couples the system bus to a local area network (“LAN”). Networking environments are commonplace in offices, enterprise-wide computer networks and home computer systems. A wide area network (“WAN”), such as the Internet, can also be accessed by the computer, a mobile device or the exoskeleton apparatus.

It may be appreciated that the type of connections contemplated herein are exemplary and other ways of establishing a communications link between computers may be used in accordance with the present invention, including, for example, mobile devices and networks. The existence of any of various well-known protocols, such as TCP/IP, Frame Relay, Ethernet, FTP, HTTP and the like, may be presumed, and computer can be operated in a client-server configuration to permit a user to retrieve and send data to and from a web-based server. Furthermore, any of various conventional web browsers can be used to display and manipulate data in association with a web-based application.

The operation of the network ready device (i.e., a mobile device) may be controlled by a variety of different program modules, engines, etc. Examples of program modules are routines, algorithms, programs, objects, components, data structures, etc. that perform particular tasks or implement particular abstract data types. It may be understood that the present invention may also be practiced with other computer system configurations, including multiprocessor systems, microprocessor-based or programmable consumer electronics, network PCS, personal computers, minicomputers, mainframe computers, and the like. Furthermore, the invention may also be practiced in distributed computing environments where tasks are performed by remote processing devices that are linked through a communications network. In a distributed computing environment, program modules may be located in both local and remote memory storage devices.

Embodiments of the present invention can be implemented by a software program for processing data through a computer system. It may be understood by a person skilled in the relevant art that the computer system can be a personal computer, mobile device, notebook computer, server computer, mainframe, networked computer (e.g., router), workstation, processor onboard the exoskeleton apparatus and the like. In one embodiment, the computer system includes a processor coupled to a bus and memory storage coupled to the bus. The memory storage can be volatile or non-volatile (i.e., transitory or non-transitory) and can include removable storage media. The computer can also include a display, provision for data input and output, etc. as may be understood by a person skilled in the relevant art.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following description, it is appreciated that throughout the present invention, references utilizing terms such as “receiving”, “creating”, “providing”, “communicating” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

The present invention is contemplated for use in association with one or more cooperating environments, to afford increased functionality and/or advantageous utilities in association with same. The invention, however, is not so limited.

Naturally, in view of the teachings and disclosures herein, persons having ordinary skill in the art may appreciate that alternate designs and/or embodiments of the invention may be possible (e.g., with substitution of one or more steps, algorithms, processes, features, structures, parts, components, modules, utilities, etc. for others, with alternate relations and/or configurations of steps, algorithms, processes, features, structures, parts, components, modules, utilities, etc.).

Although some of the steps, algorithms, processes, features, structures, parts, components, modules, utilities, relations, configurations, etc. according to the invention are not specifically referenced in association with one another, they may be used, and/or adapted for use, in association therewith.

One or more of the disclosed steps, algorithms, processes, features, structures, parts, components, modules, utilities, relations, configurations, and the like may be implemented in and/or by the invention, on their own, and/or without reference, regard or likewise implementation of one or more of the other disclosed steps, algorithms, processes, features, structures, parts, components, modules, utilities, relations, configurations, and the like, in various permutations and combinations, as may be readily apparent to those skilled in the art, without departing from the pith, marrow, and spirit of the disclosed invention.

While computer-readable storage medium may be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

It may generally be understood by a person skilled in the relevant art that the term “cloud computing” is an information technology model that facilitates ubiquitous access to shared pools of configurable system resources and higher-level services that can be provisioned with minimal management effort, usually over the Internet. Third-party clouds preferably enable organizations to focus on their core businesses instead of allocating resources on computer infrastructure and maintenance.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the present description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions.

The foregoing description has been presented for the purpose of illustration and maybe not intended to be exhaustive or to limit the invention to the precise form disclosed. Other modifications, variations and alterations are possible in light of the above teaching and may be apparent to those skilled in the art, and may be used in the design and manufacture of other embodiments according to the present invention without departing from the spirit and scope of the invention. It may be intended the scope of the invention be limited not by this description but only by the claims forming a part of this application and/or any patent issuing therefrom.

The embodiments for which an exclusive privilege or property is claimed are as follows:

1. A system for controlling an exoskeleton associated with a user, the exoskeleton comprising a body portion secured to an abdominal section of the user, a limb structure secured to one or more thighs of the user and pivotally connected to the body portion to facilitate rotation of the limb structure about a pivot axis, wherein the system comprises:
(a) one or more sensors adapted to receive input data associated with a movement of the user at a predetermined time or time intervals, the one or more sensors comprising: (i) an encoder adapted to receive movement data; and (ii) an inertial measurement unit adapted to receive physiological data;
(b) a processor operative to: (i) electronically receive the input data from the one or more sensors; (ii) automatically analyze the input data to generate output data, wherein the input data is processed by one or more algorithms to determine a torque based on the movement of the user, with the torque forming at least a part of the output data; and
(c) a drive force transmission mechanism associated with the body portion and the limb structure, the drive force transmission mechanism adapted to receive the output data from the processor and generate the torque to move the limb structure about the pivot axis;
whereby the system is operative to facilitate the control of the exoskeleton by generating the torque to support the movement of the user.

2. The system of claim 1, wherein the movement data comprises angular position, velocity and/or acceleration of the one or more thighs of the user.

3. The system of claim 1, wherein the physiological data comprises specific force and/or angular rate of the one or more thighs of the user.

4. The system of claim 1, further comprising a database for storing input data, movement data, physiological data, and/or output data.

5. The system of claims 1, wherein the one or more algorithms comprise a motion prediction algorithm, a proportional-integral-derivative algorithm, a safety detection algorithm, and/or a configuration selection algorithm.

6. The system of claim 1, wherein the input data is additionally provided by the database, a network interface device, an input-output device, and/or memory.

7. A method for controlling an exoskeleton associated with a user, the exoskeleton comprising a body portion secured to an abdominal section of the user, a limb structure secured to one or more thighs of the user and pivotally connected to the body portion to facilitate rotation of the limb structure about a pivot axis, wherein the method comprises the steps of:
(a) sensing, by one or more sensors, input data associated with a movement of the user at a predetermined time or time intervals, the input data comprising: (i) movement data; and (ii) physiological data;
(b) operating a processor to: (i) electronically receive the input data from the one or more sensors; and (ii) execute one or more algorithms to analyze the input data to automatically generate output data comprising a torque based on the movement of the user; and
(c) generating, by a drive force transmission mechanism, the torque for movement of the limb structure about the pivot axis based on the output data from the processor;
whereby the method operatively facilitates the control of the exoskeleton by generating the torque to support the movement of the user.

8. The method according to claim 7, wherein in step (a), the movement data comprises angular position, velocity and/or acceleration of the one or more thighs of the user.

9. The method according to claim 7, wherein in step (a), the physiological data comprises specific force and/or angular rate of the one or more thighs of the user.

10. The method according to claim 7, further comprising a step of electronically storing the input data, movement data, physiological data, and/or output data in a database.

11. The method according to claim 7, wherein in step (b), the one or more algorithms comprise a motion prediction algorithm, a proportional-integral-derivative algorithm, a safety detection algorithm, and/or a configuration selection algorithm.

12. The method according to claim 7, further comprising a step of receiving input data from the database, a network interface device, an input-output device, and/or memory.

13. The method according to claim 11, wherein the execution of the safety detection algorithm determines whether the torque is appropriate and further comprises a jitter detection substep, a resistance detection substep, an unintended motion detection substep and/or an imbalance substep.

14. The method according to claim 11, wherein the execution of the motion prediction algorithm comprises a substep of determining a scaling parameter associated with an assistance level for the user.

15. The method according to claim 11, wherein the execution of the proportional-integral-derivative algorithm comprises a substep of determining one or more tuning parameters associated with the generation of the torque.

16. The method according to claim 11, wherein the execution of the motion prediction algorithm or the proportional-integral-derivative algorithm further comprises a step of generating a plurality of reference configurations corresponding to the user and a specific movement, each of the plurality of reference configurations comprising the scaling parameter and the one or more tuning parameters associated with the user and the specific movement.

17. The method according to claim 16, further comprising a step of generating an input configuration based on the input data, matching a selected one of the plurality of reference configurations corresponding to the input configuration using the configuration selection algorithm, and applying the scaling parameter and the one or more tuning parameters associated with the selected one of the plurality of reference configurations to the generation of the torque.

18. A non-transient computer readable medium on which is physically stored executable instructions which, upon execution, will control an exoskeleton associated with a user, the exoskeleton comprising a body portion secured to an abdominal section of the user, a limb structure secured to one or more thighs of the user and pivotally connected to the body portion to facilitate rotation of the limb structure about a pivot axis; wherein the executable instructions comprise processor instructions for a processor to automatically:
(a) collect and/or electronically communicate input data associated with a movement of the user at a predetermined time or time intervals from one or more sensors to the processor, the one or more sensors comprising: (a) an encoder adapted to receive movement data; and (ii) an inertial measurement unit adapted to receive physiological data;
(b) automatically generate output data comprising a torque based on the movement of user using one or more algorithms and the input data; and
(c) electronically communicate the output data to a drive force transmission mechanism associated with the body portion and the limb structure to generate the torque to move the limb structure about the pivot axis;
to thus operatively facilitate the control of the exoskeleton by generating the torque to support the movement of the user.
